(19) United States
(12) Patent Application Publication
(10) Pub. No.: US 2013/0162085 A1
(43) Pub. Date: Jun. 27, 2013

(54) Electric Generator Assembly For A Vehicle

(71) Applicant: KWANG YANG MOTOR CO., LTD., Kaohsiung (TW)

(72) Inventors: Jen-Fu Yen, Kaohsiung City (TW); Hseng-Hsien Hung, Kaohsiung City (TW)

(73) Assignee: KWANG YANG MOTOR CO., LTD., Kaohsiung (TW)

(21) Appl. No.: 13/721,255

(22) Filed: Dec. 20, 2012

(30) Foreign Application Priority Data
Dec. 22, 2011 (TW) 100224261

(51) Int. Cl. H02K 5/24

(52) U.S. Cl. CPC H02K 5/24
USPC 310/91

(57) ABSTRACT

An electric generator assembly includes an electric generator, a generator support, and two shock-absorbing units. The electric generator includes a generator housing, and a rotor disposed in the generator housing and defining a central axis. The generator support has two sloped flat surfaces that are inclined to a vertical plane, on which the central axis lies. The sloped flat surfaces are disposed at two opposite sides of the vertical plane and face each other in a transverse direction relative to the vertical plane. Each of the shock-absorbing units is secured to a respective one of the sloped flat surfaces and the generator housing so as to provide a shock-absorbing effect to the electric generator.

### CROSS-REFERENCE TO RELATED APPLICATION

This application claims priority of Taiwanese Application No. 100224261, filed on Dec. 22, 2011.

### BACKGROUND OF THE INVENTION

1. Field of the Invention

This invention relates to an electric generator assembly for a vehicle, more particularly to an electric generator assembly having shock-absorbing units mounted respectively on two sloped surfaces of a generator support.

2. Description of the Related Art

Conventional four-wheel vehicles, such as an all-terrain vehicle (ATV) and a utility vehicle (UV), include a frame body, an engine, and an electric generator. The engine and the electric generator are electrically connected to each other and are supported on the frame body. The electric generator is driven by a crankshaft of the engine for generating electric power. Since the electric generator is normally fixed to the frame body of the vehicle, vibrations resulting from the motion of the crankshaft are transmitted to the frame body through the electric generator, resulting in generation of noise and discomfort to a user.

### SUMMARY OF THE INVENTION

Therefore, an object of the present invention is to provide an electric generator assembly for a vehicle that can overcome the aforesaid drawback associated with the prior art.

According to this invention, there is provided an electric generator assembly for a vehicle. The electric generator assembly comprises: an electric generator including a generator housing, and a rotor that is disposed in the generator housing and that defines a central axis; a generator support having two sloped flat surfaces that are inclined to the ground surface and a vertical plane which is perpendicular to the ground surface and on which the central axis lies, the sloped flat surfaces being disposed at two opposite sides of the vertical plane and facing each other in a transverse direction relative to the vertical plane; and two shock-absorbing units, each of which is secured to a respective one of the sloped flat surfaces and the generator housing so as to provide a shock-absorbing effect to the electric generator.

### BRIEF DESCRIPTION OF THE DRAWINGS

In drawings which illustrate an embodiment of the invention,

FIG. 1 is a fragmentary perspective view of the preferred embodiment of a generator housing assembly for a vehicle electric generator of a vehicle according to the present invention;

FIG. 2 is a fragmentary schematic side view of the preferred embodiment; and

FIG. 3 is an exploded schematic view of the preferred embodiment.

### DETAILED DESCRIPTION OF THE PREFERRED EMBODIMENT

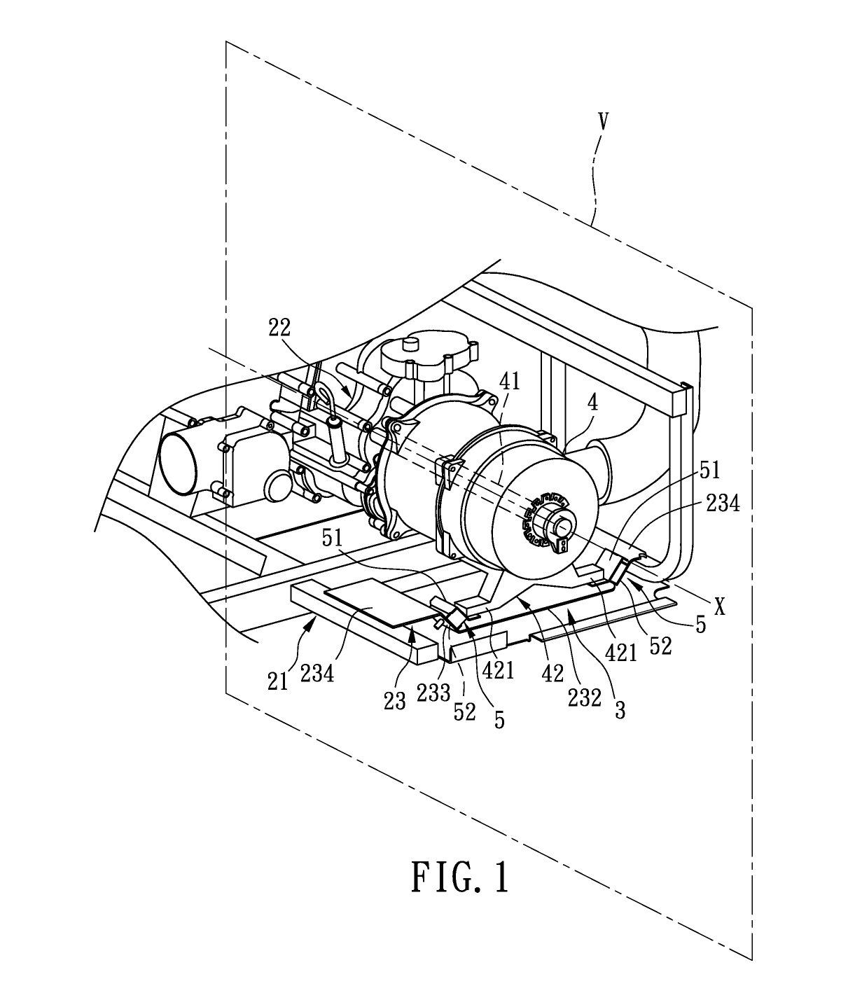

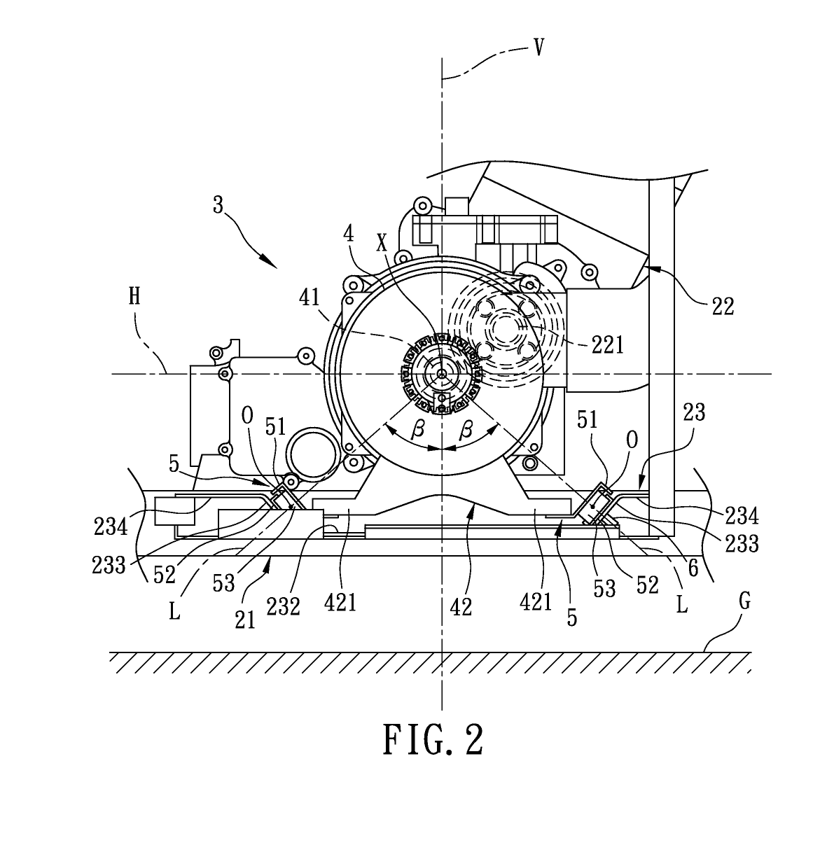

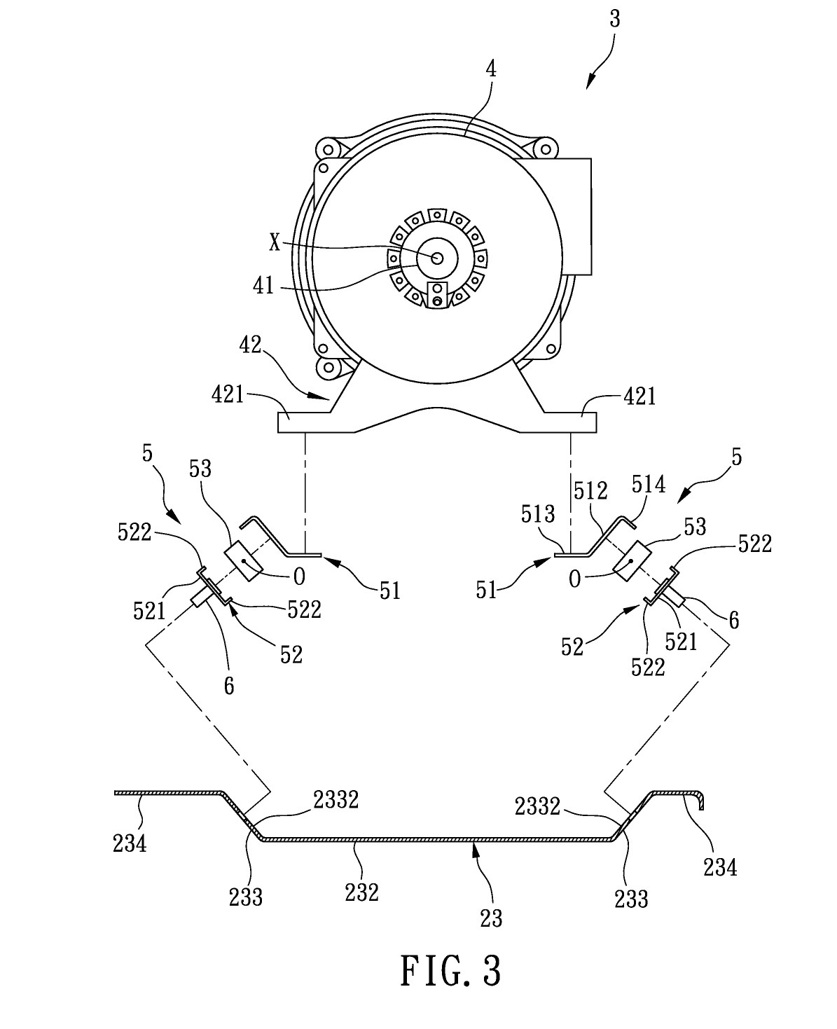

FIGS. 1 to 3 illustrate the preferred embodiment of an electric generator assembly 3 for a vehicle, such as an all-terrain vehicle (ATV) , a utility vehicle (UV) or a hybrid vehicle. The electric generator assembly 3 includes an electric generator, a generator support, and two shock-absorbing units 5.

The electric generator is connected to an engine 22 of the vehicle, and includes a generator housing 4 and a rotor 41 disposed in the generator housing 4, defining a central axis (X), and driven by a crankshaft 221 of the engine 22. The generator housing 4 is cylindrical in shape, is connected to the engine 22, and is provided with a bottom seat 42 that has two opposite feet portions 421 extending in a transverse direction (H) perpendicular to a vertical plane (V) which is perpendicular to the ground surface (G) and on which the central axis (X) lies. The feet portions 421 are respectively disposed at two opposite sides of the vertical plane (V) below the rotor 41, and are opposite to each other in the transverse direction (H).

The generator support includes a vehicle frame body 21 and a slope-providing plate 23 secured to the vehicle frame body 21 . The slope-providingplate 23 has two opposite wing portions 234 that are opposite to each other in the transverse direction (H) and that are mounted securely on the vehicle frame body 21, two opposite sloped portions 233 disposed between and extending inclinedly and respectively from the wing portions 234, and a central portion 232 extending between the sloped portions 233 in the transverse direction (H) andbeing seated on the vehicle frame body 21. The sloped portions 233 are opposite to each other in the transverse direction (H), are inclined to the vertical plane (V) and the ground surface (G), and respectively define two sloped flat surfaces 2332 opposite to the vehicle frame body 21 and facing the electric generator. The sloped flat surfaces 2332 are respectively disposed at the two opposite sides of the vertical plane (V), are opposite to and face each other in the transverse direction (H), and are inclined to the ground surface (G) and the vertical plane (V).

Each of the shock-absorbing units 5 is resiliently compressible, is secured to and interconnects a respective one of the sloped flat surfaces 2332 and the generator housing 4 so as to provide a shock-absorbing effect to the electric generator, and includes a compressible resilient member 53, first and second holding plates 51, 52, and a bolt 6.

In this embodiment, the resilient member 53 of each of the shock-absorbing units 5 is in the form of a rectangular rubber block. Alternatively, the resilient member 53 of each of the shock-absorbing units 5 can be a coil spring in other embodiments. The compressible resilient member 53 of each of the shock-absorbing units 5 has a geometric center (O), and cooperates with the central axis (X) to define a cushioning centerline (L) which passes through the geometric center (O) and the central axis (X), which is perpendicular to the central axis (X), and which forms an acute angle (β) with the vertical plane (V).

The first and second holding plates 51, 52 of each of the shock-absorbing units 5 are secured to the generator housing 4 and a respective one of the sloped flat surfaces 2332, respectively. The resilient member 53 is sandwiched between and is secured to the first and second holding plates 51, 52. The cushioning centerlines (L) defined by the central axis (X) and the geometric centers (0) of the compressible resilient members 53 of the shock-absorbing units 5 intersect each other at the central axis (X).

The first holding plate 51 has a middle portion 512, a contact portion 513 extending inclinedly from one side of the middle portion 512 in the transverse direction (H), and a side portion 514 extending transversely from an opposite side of the middle portion 512 to confine one side of the resilient member 53. The feet portions 421 of the bottom seat 42 are attached securely to the contact portions 513 of the first holding plates 51 of the shock-absorbing units 5, respectively. The second holding plate 52 has a base portion 521 and two arm portions 522 extending from two opposite sides of the base portion 521, respectively. The resilient member 53 of each of the shock-absorbing units 5 is sandwiched between and is secured to the middle portion 512 of a respective one of the first holding plate 51 and the base portion 521 of a corresponding one of the second holding plates 52, and is fittingly disposed between the arm portions 522 of the corresponding one of the second holding plates 52. The base portions 521 of the second holding plates 52 of the shock-absorbing units 5 are attached securely to the sloped flat surfaces 2332, respectively, and are fastened to the sloped portions 233 of the slope-providing plate 23 through the bolts 6, respectively. Each of bolts 6 extends along a respective one of the cushioning centerlines (L).

With the inclusion of the slope-providing plate 23 and the shock-absorbing units 5 in the electric generator assembly 3 of the present invention, the aforesaid drawback associated with the prior art can be alleviated. In addition, by designing the sloped portions 233 to have slopes in a manner that the cushioning centerlines (L) intersect each other at the central axis (X) and that each of the cushioning centerlines (L) forms an acute angle (β) with the vertical plane (V), the vibration transmitted from the engine 22 to the vehicle frame body 21 can be considerably reduced. Moreover, the use of the slope-providing plate 23 facilitates the mounting of the shock-absorbing units 5 on the vehicle frame body 21 to cushion the electric generator without making a considerable change on the structure of the vehicle frame body 21.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An electric generator assembly for a vehicle, comprising:
an electric generator including a generator housing, and a rotor that is disposed in said generator housing and that defines a central axis;
a generator support having two sloped flat surfaces that are inclined to the ground surface and a vertical plane which is perpendicular to the ground surface and on which said central axis lies, said sloped flat surfaces being disposed at two opposite sides of said vertical plane and facing each other in a transverse direction relative to said vertical plane; and
two shock-absorbing units, each of which is secured to a respective one of said sloped flat surfaces and said generator housing so as to provide a shock-absorbing effect to said electric generator.

2. The electric generator assembly of claim 1, wherein each of said shock-absorbing units includes a compressible resilient member that has a geometric center and that cooperates with said central axis to define a cushioning centerline which passes through said geometric center and said central axis, which is perpendicular to said central axis, and which forms an acute angle with said vertical plane.

3. The electric generator assembly of claim 2, wherein said cushioning centerlines of said compressible resilient members of said shock-absorbing units intersect each other at the central axis.

4. The electric generator assembly of claim 2, wherein each of said shock-absorbing units further includes first and second holding plates secured to said generator housing and the respective one of said sloped flat surfaces, respectively, said resilient member being sandwiched between and being secured to said first and second holding plates.

5. The electric generator assembly of claim 4, wherein said first holding plate has a middle portion and a contact portion extending inclinedly from one side of said middle portion in said transverse direction, said generator housing being provided with a bottom seat secured to said contact portion of said first holding plate of each of said shock-absorbing units, said second holding plate having a base portion and two arm portions extending from two opposite sides of said base portion, respectively, said resilient member being sandwiched between and being secured to said middle portion and said base portion and being fittingly disposed between said arm portions, said base portion of said second holding plate of each of said shock-absorbing units being attached securely to the respective one of said sloped flat surfaces.

6. The electric generator assembly of claim 5, wherein said bottom seat has two opposite feet portions which are respectively disposed at said opposite sides of said vertical plane below said rotor and each of which is attached securely to said contact portion of said first holding plate of a corresponding one of said shock-absorbing units.

7. The electric generator assembly of claim 6, wherein said feet portions of said bottom seat extend in said transverse direction.

8. The electric generator assembly of claim 6, wherein said generator support includes a slope-providing plate that has two opposite wing portions that are opposite to each other in said transverse direction, and two opposite slopedportions disposed between and extending respectively from said wing portions, said wing portions extending in said transverse direction and being adapted to be mounted securely on a vehicle frame body of the vehicle, said slopedportions being inclined to said vertical plane and defining said sloped flat surfaces, respectively.

9. The electric generator assembly of claim 8, wherein each of said shock-absorbing units further includes a bolt extending along a respective one of said cushioning centerlines, said base portion of said second holding plate of each of said shock-absorbing units being fastened to a corresponding one of said sloped portions of said slope-providing plate through said bolt.
